(19) United States
(12) Patent Application Publication
(10) Pub. No.: US 2026/0153980 A1
(43) Pub. Date: Jun. 4, 2026

(54) METHOD AND APPARATUS FOR FORWARDING AND DISPLAYING MEDIA CONTENT, DEVICE AND PRODUCT

(71) Applicant: Beijing Zitiao Network Technology Co., Ltd., Beijing (CN)

(72) Inventors: Chengcai GAO, Beijing (CN); Yuhan GAO, Beijing (CN); Zimao NIU, Beijing (CN); Hongqiang QIAN, Beijing (CN); Yong CHEN, Beijing (CN); Jiaqi PENG, Beijing (CN); Bo QIU, Beijing (CN)

(21) Appl. No.: 19/330,539

(22) Filed: Sep. 16, 2025

(30) Foreign Application Priority Data
Nov. 29, 2024 (CN) 202411750858.X

(51) Int. Cl. G06F 3/04847; G06T 11/60; H04N 21/2187

(52) U.S. Cl. CPC G06F 3/04847; G06T 11/60; H04N 21/2187

(57) ABSTRACT

The present disclosure relates to method and apparatus for forwarding and displaying media content, a device and a product. The method comprises in response to detecting a touch on a first control by a user, obtaining information of media content, the media content including a video, image-text, a mixed arrangement of views and live streaming; the media content information including an identifier of the media content, and forwarding information; the mixed arrangement of views indicating mixed views(video-picture); the forwarding information including a user interface style of the media content, a background color of the media content and a new script of user. The method also comprises generating submission data by associating the media content with information of the media content. Moreover, the method also comprises, in response to detecting a touch on a second control by a user, forwarding the media content based on the submission data.

### CROSS-REFERENCE TO RELATED APPLICATION(S)

This application claims priority to Chinese Application No. 202411750858.X, filed on Nov. 29, 2024, the disclosure of which is incorporated herein by reference in its entirety.

### FIELD

The present disclosure relates to computer field, and more specifically to method and apparatus for forwarding and displaying media content, a device and a product.

### BACKGROUND

On video platforms, users have access to publish various media content and the contents include video and image-text forms. Meanwhile, other users on the platforms are also capable of interacting with such media content. They may interact with other users by touching the interaction control. In addition, some users also may choose to forward the contents of interest to their own social networks, to share them with more friends.

### SUMMARY

In a first aspect of the embodiments of the present disclosure, there is provided a method for forwarding media content. The method comprises in response to detecting a touch on a first control by a user, obtaining information of media content, wherein the media content comprises at least one of a video, image-text, a mixed arrangement of views and live streaming, and information of the media content includes an identifier of the media content and forwarding information, and the mixed arrangement of views indicates a mixed arrangement of a video and a picture, the forwarding information comprising at least one of a user interface style of the media content, a background color of the media content and a new script of user. The method also comprises generating submission data by associating with the media content and information of the media content. Moreover, the method also comprises, in response to detecting a touch on a second control by a user, forwarding the media content based on the submission data.

In a second aspect of the embodiments of the present disclosure, there is provided an apparatus for forwarding media content. The apparatus comprises an information obtaining module configured to obtain information of media content in response to detecting a touch on a first control by a user, wherein the media content comprises at least one of a video, image-text, a mixed arrangement of views and live streaming, and information of the media content includes an identifier of the media content and forwarding information, and the mixed arrangement of views indicates a mixed arrangement of a video and a picture, the forwarding information comprising at least one of a user interface style of the media content, a background color of the media content and a new script of user. The apparatus also comprises a submission data generating module configured to generate submission data by associating with the media content and information of the media content. Further, the apparatus also comprises media content forwarding module configured to forward the media content based on the submission data in response to detecting a touch on a second control by a user.

In a third aspect of the embodiments of the present disclosure, there is provided an electronic device. The electronic device comprises one or more processors; and a memory for storing one or more programs, wherein the one or more programs, when executed by one or more processors, cause the one or more processors to implement a method for forwarding media content. The method comprises in response to detecting a touch on a first control by a user, obtaining information of media content, wherein the media content comprises at least one of a video, image-text, a mixed arrangement of views and live streaming, and information of the media content includes an identifier of the media content and forwarding information, and the mixed arrangement of views indicates a mixed arrangement of a videos and a picture, the forwarding information comprising at least one of a user interface style of the media content, a background color of the media content and a new script of user. The method also comprises generating submission data by associating with the media content and information of the media content. Moreover, the method also comprises, in response to detecting a touch on a second control by a user, forwarding the media content based on the submission data.

In a fourth aspect of the embodiments of the present disclosure, there is provided a computer program product. The computer program product is tangibly stored on a non-transitory computer-readable medium and comprises machine-executable instructions, wherein the machine-executable instructions, when executed, cause a machine to implement a method for forwarding media content. The method comprises in response to detecting a touch on a first control by a user, obtaining information of media content, wherein the media content comprises at least one of a video, image-text, a mixed arrangement of views and live streaming, and information of the media content includes an identifier of the media content and forwarding information, and the mixed arrangement of views indicates a mixed arrangement of a video and a picture, the forwarding information comprising at least one of a user interface style of the media content, a background color of the media content and a new script of user. The method also comprises generating submission data by associating with the media content and information of the media content. Moreover, the method also comprises, in response to detecting a touch on a second control by a user, forwarding the media content based on the submission data.

In a fifth aspect of the embodiments of the present disclosure, there is provided a method for displaying media content. The method comprises in response to detecting an operation of browsing the media content by a user, obtaining submission data, wherein the submission data is at least associated with the media content and information of the media content, and information of the media content at least includes an identifier of the media content and forwarding information, and wherein the forwarding information comprises at least one of a user interface style of the media content, a background color of the media content and a new script of user. The method also comprises parsing the submission data to obtain the parsed media content and information of the media content. Moreover, the method further comprises displaying the media content hierarchically based on the media content and information of the parsed media content.

In a sixth aspect of the present disclosure, there is provided an apparatus for displaying media content. The apparatus comprises a submission data obtaining module configured to obtain submission data in response to detecting an operation of browsing the media content by a user, wherein the submission data is at least associated with the media content and information of the media content, and information of the media content at least includes an identifier of the media content and forwarding information, and wherein the forwarding information comprises at least one of a user interface style of the media content, a background color of the media content and a new script of user. The apparatus also comprises a submission data parsing module configured to parse the submission data to obtain the parsed media content and information of the media content. Moreover, the apparatus also comprises media content display module configured to display the media content hierarchically based on the parsed media content and information of the media content.

In a seventh aspect of the embodiments of the present disclosure, there is provided an electronic device. The electronic device comprises one or more processors; and a memory for storing one or more programs, wherein the one or more programs, when executed by one or more processors, cause the one or more processors to implement a method for displaying media content. The method comprises in response to detecting an operation of browsing the media content by a user, obtaining submission data, wherein the submission data is at least associated with the media content and information of the media content, and information of the media content at least includes an identifier of the media content and forwarding information, and wherein the forwarding information comprises at least one of a user interface style of the media content, a background color of the media content and a new script of user. The method also comprises parsing the submission data to obtain the parsed media content and information of the media content. Moreover, the method further comprises displaying the media content hierarchically based on the media content and information of the parsed media content.

In an eighth aspect of the embodiments of the present disclosure, there is provided a computer program product. The method comprises in response to detecting an operation of browsing the media content by a user, obtaining submission data, wherein the submission data is at least associated with the media content and information of the media content, and information of the media content at least includes an identifier of the media content and forwarding information, and wherein the forwarding information comprises at least one of a user interface style of the media content, a background color of the media content and a new script of user. The method also comprises parsing the submission data to obtain the parsed media content and information of the media content. Moreover, the method further comprises displaying the media content hierarchically based on the media content and information of the parsed media content.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features of the present disclosure will be understood more easily through the following description.

### BRIEF DESCRIPTION OF THE DRAWINGS

With reference to the drawings and the following detailed description, the above and other features, advantages and aspects of various embodiments of the present disclosure will become more apparent. In the drawings, same or similar reference signs indicate same or similar elements, wherein:

FIG. 1 illustrates a schematic diagram of an example environment 100 in which a plurality of embodiments according to the present disclosure may be implemented;

FIG. 2A illustrates a flowchart of a method for forwarding media content in accordance with some embodiments of the present disclosure;

FIG. 2B illustrates a flowchart of a method for displaying media content in accordance with some embodiments of the present disclosure;

FIG. 3 illustrates a schematic diagram of an example procedure for displaying related media content at other users after some users forward the media content in accordance with some embodiments of the present disclosure;

FIG. 4 illustrates a schematic diagram of an example process for exchange of media content between the production side and the consumption side in accordance with some embodiments of the present disclosure;

FIGS. 5A-5F illustrate schematic diagrams of example interfaces for forwarding and displaying media content in accordance with some embodiments of the present disclosure;

FIG. 6A illustrates a block diagram of an apparatus for forwarding media content in accordance with some embodiments of the present disclosure;

FIG. 6B illustrates a block diagram of an apparatus for displaying media content in accordance with some embodiments of the present disclosure; and

FIG. 7 illustrates a block diagram of a device capable of implementing a plurality of embodiments of the present disclosure.

### DETAILED DESCRIPTION OF EMBODIMENTS

It is to be appreciated that all user-related data involved in the technical solution should be obtained and used after user authorization. This means that if the personal information of the users is to be used in the technical solution, explicit consent and authorization shall be given by the users before obtaining the personal information; otherwise, related data would not be collected and used. It also should be understood that in implementing the technical solution, one shall strictly follow relevant laws and regulations during collection, usage and storage of the data and take necessary techniques and measures to guarantee user data safety and ensure safe usage of data.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

Media content takes various forms, including texts, images, audios and videos or combinations thereof. In the field of media content creation, production side usually refers to users or teams who create, make or produce media content. They use all kinds of tools and techniques to create media content. Consumption side, on the other hand, indicates those users who browse, view or receive the media content. They access and view the media content via different platforms or devices (such as mobile phones, computers and televisions etc.). Preferences, feedback and interactions (e.g., likes, comments, sharing and forwarding etc.) of the consumption-side users are very important for the production-side users because they can affect the creation direction and motivation of the production-side users. In general, the production side is a party that creates the media content while the consumption side is a party that views the media content. They depend on each other and collectively constitute the ecosystem of the media content.

As stated above, the users on the video platforms are able to interact with the public media content published by other users. For example, some users also may choose to forward the media content of interest to their own social networks and share them with more friends. While forwarding the media content, the users also may conduct secondary creation on such media content, for example, by adding their own secondary creation scripts and effects among other materials. In the related art, when the users are forwarding related media content, it is required to download the raw materials of the media content and then add a related forwarding format (e.g., the secondary creation scripts and effect materials of the users), to re-synthesize a new media content to be published. However, this publishing method based on re-synthesis slows down the speed of forward and submission by the user and the definition of the media content published through re-synthesis often fail to meet the visual requirements of the users. Besides, in the related art, the publishing method based on re-synthesis can only be applied to forward media content in particular forms, e.g., single video or single picture. Meanwhile, in forwarding by the publishing method based on re-synthesis, it is impossible to adjust the interactive style of the published media content viewed by the users at the consumption side.

For this, the present disclosure proposes a method for forwarding and displaying media content. When the users forward the media content, the re-synthesis is no longer required, i.e., the users can directly forward the media content. Upon touching a first control, the user (i.e., the production-side user) may first obtain information of the media content. The media content may be in any of the following forms: videos, image-texts, mixed arrangements of views or live streaming etc. The obtained information of the media content includes identifier of the media content and the user-related forwarding information. Afterwards, the media content may be associated only with their information to generate a piece of submission data (without synthesizing into a complete media content). When touching a second control, the user may forward the media content based on this piece of submission data. When it is detected that some further users (i.e., consumption-side users) are browsing the forwarded media content, the submission data related to the media content are obtained first and then parsed to gain related media content and media content information. The media content is displayed hierarchically on the basis of the parsed media content and the information of the media content.

The method free of resynthesizing media content can facilitate exchange of the media content at production and consumption sides. In addition to forwarding various types of media content, this method also expedites the speed for publishing the media content forwarded by the production-side users. In addition, the visual effects of these forwarded media content viewed by the consumption-side users are also enhanced and the user experience is therefore improved.

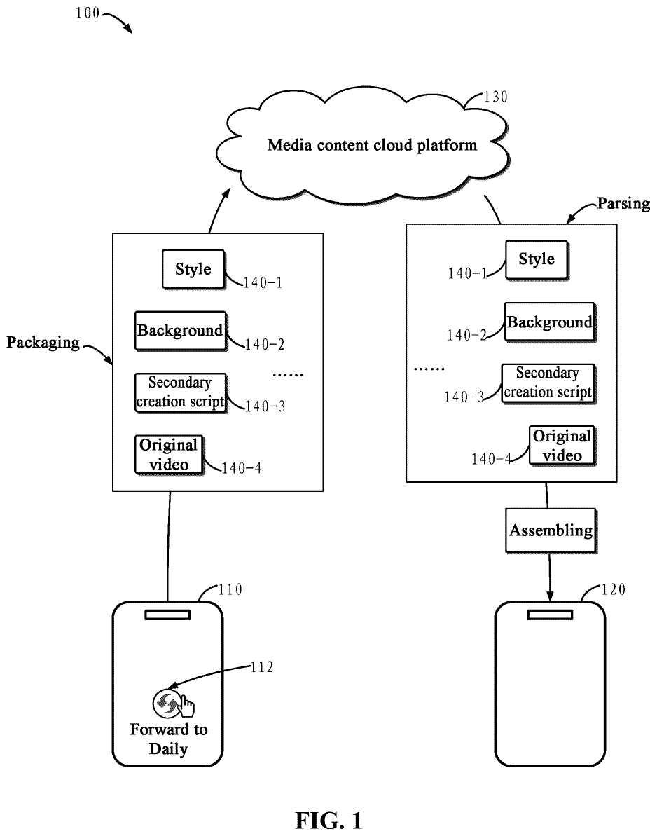

FIG. 1 illustrates a schematic diagram of an example environment 100 in which a plurality of embodiments according to the present disclosure may be implemented. As shown in FIG. 1, the example environment 100 may include a terminal device 110, media content cloud platform 130 and a terminal device 120. In the embodiments of the present disclosure, the terminal device may be any device capable of sending and receiving information, which may be mobile phone, tablet computer, notebook computer, laptop computer, smart TV, intelligent printer, intelligent household electrical appliance, on-board terminal, wearable device (smart watch, smart bracelet, smart glasses etc.), virtual reality (VR) device and augmented reality (AR) device etc. Embodiments of the present disclosure are not restricted in this regard.

The media content cloud platform 130 may be a computing system, a single server or a distributed server etc. Embodiments of the present disclosure are not restricted in this regard. The media content cloud platform 130 may be a server providing media content and may be used for receiving, pushing and storing media content. Terminal device 110 and terminal device 120 may obtain media content from the media content cloud platform 130. In the embodiments of the present disclosure, the production-side user may publish (including forward) the media content by means of the media content cloud platform 130 through the terminal device 110. The media content cloud platform 130 may receive from the terminal device 110 the related data of the media content forwarded by the production-side user and push to the terminal device 120, such that the consumption-side user may obtain via the terminal device 120 the media content forwarded by the production-side user as pushed by the media content platform. In some embodiments, the media content may be in various forms, including videos, image-texts, mixed arrangements of views, live streaming, single image-text and single video etc. Embodiments of the present disclosure are not restricted in this regard.

In some embodiments, when it is detected that the production-side user touches a “Forward to Daily” control 112 on the terminal device 110, the terminal device 110 may package the obtained related data of the media content forwarded by the production-side user to generate a piece of submission data, which is uploaded to the media content cloud platform 130, thereby forwarding and publishing the media content. In some embodiments, the obtained information of the media content may be divided into identifier and forwarding information of the media content, wherein the forwarding information may be split into user style, background, created script of the media content etc. It is to be appreciated that the touch may include click, slide and voice control etc.

In some embodiments, in case that the media content is a video work, the submission data associated with the style 140-1 of the media content, the background 140-2 of the media content, the secondary creation script 140-3 of the production-side user and/or the original video 140-4 may be packaged. It is to be understood that “associate” here indicates a certain relation among the packaged data, e.g., the data may be associated by a certain master key. In other words, a binding relation is established between the forwarding information of the forwarding user and the forwarded media content.

In some embodiments, the original video 140-4 may have already been stored on the media content cloud platform 130. In such case, the identifier (ID) of the original video 140-4 is packaged. In some embodiments, the style 140-1 may be User Interface Style in which the media content is displayed, where the user interface style indicates a combination of visual and interactive elements used for designing the user interface (UI). In some embodiments, the background 140-2 may be a background color of the media content. In some embodiments, the secondary creation script 140-3 may be thoughts and scripts of the production-side user. In other words, the original video 140-4 may correspond to identifier of the media content; the style 140-1 of the media content, the background 140-2 of the media content and the secondary creation script 140-3 of the production-side user correspond to the forwarding information. The above is collectively known as the information of the media content.

In some embodiments, when it is detected that the production-side user touches a publish control of the forwarded media content, the media content cloud platform 130 may push the media content forwarded by the production-side user to the terminal device based on the packaged submission data, such that the consumption side user may browse the media content forwarded and published by the production-side user at the terminal device 120.

While the production-side user forwards the media content, the submitting method free of re-synthesis avoids degraded quality resulted from downloading and synthesizing the raw materials of the media content, maintains the definition of the original media content, and also expedites the speed for publishing the forwarded media content by the production-side user. The user experience is therefore improved.

In some embodiments, when it is detected that the consumption-side user browses the media content forwarded and published by the production-side user through the terminal device 120, the submission data related to the media content may be downloaded from the media content cloud platform 130 and parsed to obtain the style 140-1, the background 140-2, the secondary creation script 140-3 and/or the original video 140-4 of the media content etc.

In some embodiments, the parsed submission data may be assembled to gain media content displayed on the terminal 120. In some embodiments, the media content may be assembled via an external playback container based on the parsed submission data, so as to display the media content forwarded and published by the production-side user hierarchically on the terminal device 120 of the consumption-side user. Alternatively, since the media content displayed on the terminal device of the consumption-side user is obtained through assembling, the interactive style of the media content displayed at the consumption side may also be adjusted by modifying the user interface style of the media content. While the consumption-side user is browsing the media content forwarded and published by the production-side user, the method of displaying the media content in a hierarchical nesting mode through assembling the submission data improves the browsing experience of the consumption-side user.

It is to be appreciated that the architecture and the function in the example environment 100 are described only for illustrative purpose, without suggesting any restrictions over the scope of the present disclosure. Embodiments of the present disclosure also may be applied to other environments with different structures and/or functions. For example, in some embodiments, the environment 100 also may include a plurality of terminals. In some embodiments, the terminal device 110 can directly communicate with the terminal device 120.

The method free of re-synthesizing the media content facilitates exchange of the media content between the production and the consumption sides. In addition to allowing the production-side user to forward various types of media content, the method also expedites the speed for publishing the media content forwarded by the production-side user. Moreover, the visual effects of these forwarded media content viewed by the consumption-side users are also enhanced and the user experience is therefore improved.

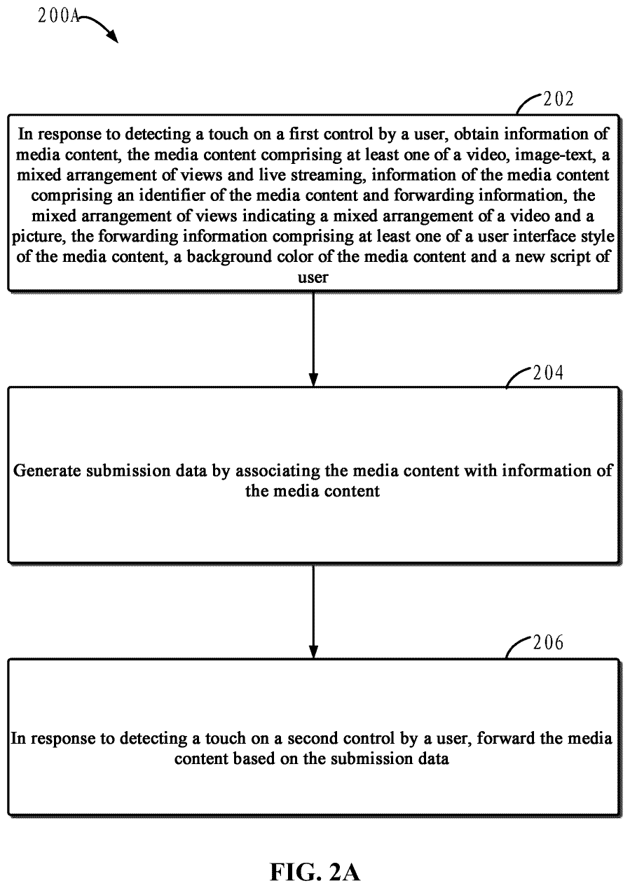

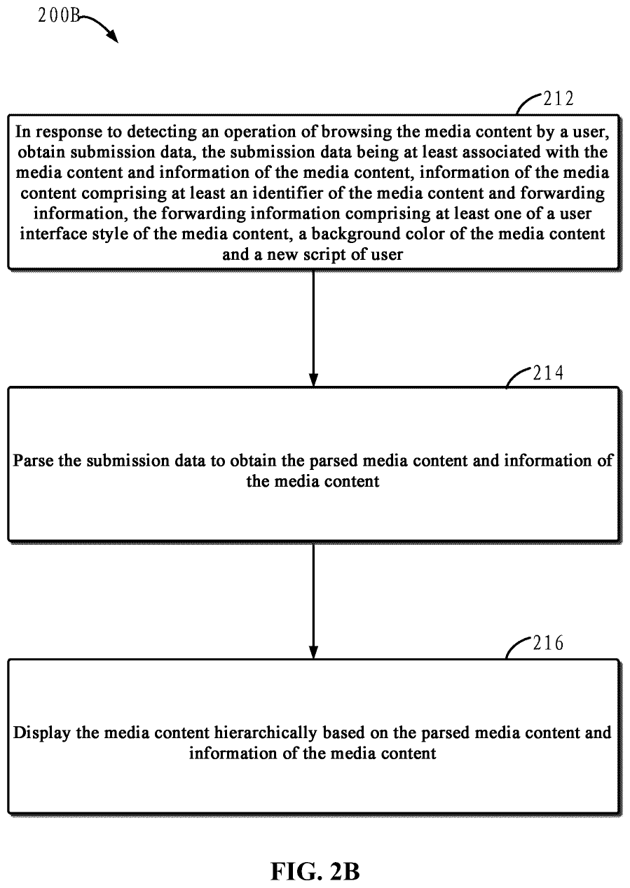

The method according to embodiments of the present disclosure is to be described below in details with reference to FIGS. 2A-7. To facilitate understanding, the specific data mentioned in the following description are only exemplary and shall not be used to define the protection scope of the present disclosure. It is to be appreciated that the embodiments described below also may include additional acts not shown and/or omit the illustrated acts. The scope of the present disclosure is not restricted in this regard.

FIG. 2A illustrates a flowchart of a method 200A for forwarding media content in accordance with some embodiments of the present disclosure. The method 200A may be executed by an apparatus for forwarding media content. The apparatus, for example, may be an independent apparatus or system. The apparatus may be implemented by software and/or hardware. Next, the method 200A is schematically explained with the apparatus for forwarding media content as the executive body. The method 200A includes a block 202, a block 204 and a block 206.

As shown in FIG. 2A, at block 202, in response to detecting a touch on a first control by a user, information of media content is obtained, wherein the media content comprises at least one of a video, image-text, a mixed arrangement of views and live streaming, and information of the media content comprises an identifier of the media content and forwarding information, and the mixed arrangement of views indicates a mixed arrangement of a video and a picture, the forwarding information comprising at least one of a user interface style of the media content, a background color of the media content and a new script of user. Referring to FIG. 1, in some embodiments, when it is detected that the production-side user touches a “Forwarding to Daily” control 112 on the terminal device 110, the terminal device 110 may obtain related data of the media content forwarded by the production-side user. In some embodiments, the obtained information of the media content may be divided into identifier and forwarding information of media content, wherein the forwarding information may be split into user style, background, created text of the media content etc. The mixed arrangement of the views is a special way for mixed displaying the pictures and the videos.

In some embodiments, in case that the media content is a video work, the submission data associated with the style 140-1 of the media content, the background 140-2 of the media content, secondary creation script 140-3 of the production-side user and/or the original video 140-4 may be packaged. In some embodiments, the original video 140-4 may have already been stored on the media content cloud platform 130. In such case, the identifier (ID) of the original video 140-4 is packaged. In some embodiments, the style 140-1 may be User Interface Style in which the media content is displayed, where the user interface style indicates a combination of visual and interactive elements used for designing the user interface (UI). In some embodiments, the background 140-2 may be a background color of the media content. In some embodiments, the secondary creation script 140-3 may be thoughts and scripts of the production-side user. In other words, the original video 140-4 may correspond to identifier of the media content; the style 140-1 of the media content, the background 140-2 of the media content and the secondary creation script 140-3 of the production-side user correspond to the forwarding information. The above is collectively known as the information of the media content.

At block 204, the method includes generating the submission data by associating the media content with the information of the media content. Referring to FIG. 1, in some embodiments, in case that the media content is a video work, the submission data associated with the style 140-1 of the media content, the background 140-2 of the media content, secondary creation script 140-3 of the production-side user and/or the original video 140-4 may be packaged. In replacement of the method for re-synthesizing media content, the submission data is generated by associating with the media content and the information of the media content, to avoid reducing definition of the media content forwarded by the user due to the re-synthesis.

At block 206, in response to detecting a touch on a second control by a user, the media content is forwarded based on the submission data. With reference to FIG. 1, in some embodiments, when it is detected that the production-side user touches a publish control of the forwarded media content, the media content cloud platform 130 may push the media content forwarded by the production-side user to the terminal device based on the packaged submission data.

While the production-side user forwards the media content, the submitting method free of re-synthesis maintains the definition of the original media content, and also expedites the speed for publishing the media content forwarded by the production-side user. The user experience is therefore improved.

FIG. 2B illustrates a flowchart of a method 200B for displaying media content in accordance with some embodiments of the present disclosure. The method 200B may be executed by an apparatus for displaying media content. The apparatus, for example, may be an independent apparatus or system. The apparatus may be implemented by software and/or hardware. Next, the method 200B is schematically explained with the apparatus for displaying media content as the executive body. The method 200B includes a block 212, a block 214 and a block 216.

As shown in FIG. 2B, at block 212, in response to detecting an operation of browsing the media content by a user, submission data is obtained, wherein the submission data is at least associated with the media content and information of the media content; information of the media content at least comprises an identifier of the media content and forwarding information, and wherein the forwarding information comprises at least one of a user interface style of the media content, a background color of the media content and a new script of user. Referring to FIG. 1, in some embodiments, when it is detected that the consumption-side user browses the media content forwarded and published by the production-side user through the terminal device 120, the submission data related to the media content may be obtained from the media content cloud platform 130. In some embodiments, the submission data is at least associated with the media content and the information of the media content, wherein the information of the media content may include identifier of the media content and the forwarding information. In some embodiments, the forwarding information may at least include the user interface style of the media content, the background color of the media content and the new script of the user etc.

At block 214, the submission data is parsed to obtain the parsed media content and information of the media content. With reference to FIG. 1, in some embodiments, after the submission data related to the media content are obtained from the media content cloud platform 130, the submission data may be parsed to obtain the style 140-1, the background 140-2, the secondary creation script 140-3 and/or the original video 140-4 of the media content etc.

At block 216, the media content is displayed hierarchically based on the parsed media content and information of the media content. According to FIG. 1, in some embodiments, after the parsed style 140-1, background 140-2, secondary creation script 140-3 and/or original video 140-4 of the media content are obtained, the parsed submission data may be assembled to gain media content displayed on the terminal 120. In some embodiments, the media content may be assembled via an external playback container based on the parsed submission data, so as to display the media content forwarded and published by the production-side user hierarchically on the terminal device 120 of the consumption-side user. While the consumption-side user is browsing the media content forwarded and published by the production-side user, the method of displaying the media content hierarchically through assembling improves the browsing experience of the consumption-side user.

With reference to the method 200A and the method 200B, the method free of re-synthesizing the media content facilitates exchange of media content between the production and the consumption sides. In addition to allowing the production-side user to forward and publish various types of media content, the method also expedites the speed for publishing the media content forwarded by the production-side user. Moreover, the visual effects of these forwarded media content when viewed by the users at the consumption side are also enhanced and the user experience is therefore improved.

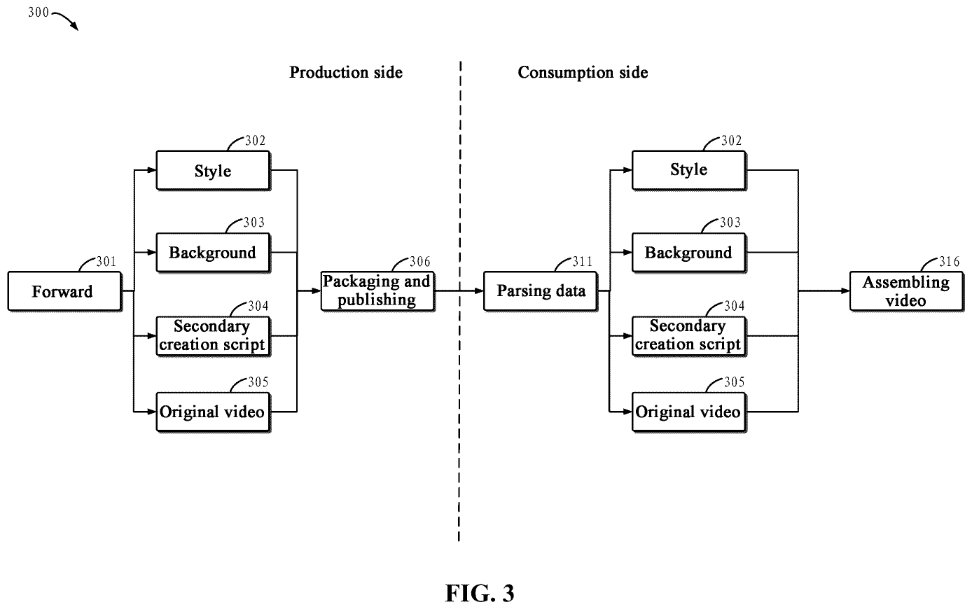

FIG. 3 illustrates a schematic diagram of an example procedure 300 for displaying related media content at other users after some users forward the media content in accordance with some embodiments of the present disclosure. As stated above, the product side is a party that creates media content and the consumption side is a party that views media content. With reference to FIG. 3, the left side is the production side, at which the user may create and publish media content, including original publication, forward or processed forward etc. The right side of FIG. 3 is the consumption side, at which the user may access and view such media content through different platforms or devices (such as mobile phones, computers and televisions etc.).

Referring to FIG. 3, the method for submission and forward without synthesis in some embodiments of the present disclosure is described below with an example of the media content being video. The forward may be summarized as a process of passing an existing piece of information, message, post, article, video, picture or content in other types from the original source or publisher to a further one or more receivers (which may be an individual, a group or public) through user's operation.

As shown in FIG. 3, the production-side user may propagate the video that has been published by another user through forward 301. In some embodiments, the production-side user may perform an operation of forwarding a video of another user by manipulating a forward control on the terminal device.

According to FIG. 3, in some embodiments, when the operation on the forward control by the production-side user is detected, the information related to the video (e.g., the original video 305 shown in FIG. 3) may be obtained, wherein the information may include ID and the forwarding information of the video. In some embodiments, the forwarding information may be the user design style 302 of the video, the background 303 of the video and the secondary creation script 304 of the production-side user etc. If the production-side user directly forwards the video without adding additional information like secondary creation script 304, the packaging is no longer required.

As the definition of the video forwarded through re-synthesis is too low, the process of re-synthesizing the video is abandoned in some embodiments of the present disclosure. In some embodiments, it is only required to associate the video information with the video ID and package them to generate the submission data, so as to forward the video by packaging and further publishing the submission data at 306. The method without synthesizing a new video avoids the disadvantages caused by downloading the original video, expedites the forward and submission speed of the production-side user and enhances the user experience.

In some embodiments, the associated data of the video may be packaged to pass to the server, e.g., the video cloud platform. In some embodiments, after forwarding the video, the production-side user also may view the forwarded video at the production side. In some embodiments, the forwarded video may be presented by an external player.

After the production-side user forwards the video via the video cloud platform, the video cloud platform may receive the data related to the video forwarded by the production-side user and push the data to the consumption-side user, such that the consumption-side user may obtain the video forwarded by the production-side user as pushed by the video platform via the terminal device.

Referring to FIG. 3, when it is detected that the consumption-side user browses the video forwarded by the production-side user, the submission data related to the video may be downloaded from the video cloud platform and parsed at 311, to obtain the style 302 of the video, the background 303 of the video, the secondary creation script 304 of the video (if any) and the identifier of the original video 305. Next, in some embodiments, the parsed data may be assembled at 316 to obtain the video forwarded by the production-side user. In some embodiments, the external player may be adopted to nested display and play the video based on the forward style (including background and user interface style etc.) and the parsed data. The external player may be a device or software that fulfills the media play function by connection or additional ways. The external player can play media files in various formats, including but not limited to, videos, audios and pictures etc. The method for nested playing the forwarded video by means of the external player can achieve the effect of lossless quality of the forwarded video.

As can be seen from the example procedure 300 for displaying related media content at other users after some users forward the media content illustrated in FIG. 3, the method free of re-synthesizing the media content facilitates exchange of videos between the production and the consumption sides. In addition to expediting the speed for publishing the video forwarded by the production-side user, the method also can enhance the visual effects of these forwarded media content when viewed by the users at the consumption side, and further improve the user experience.

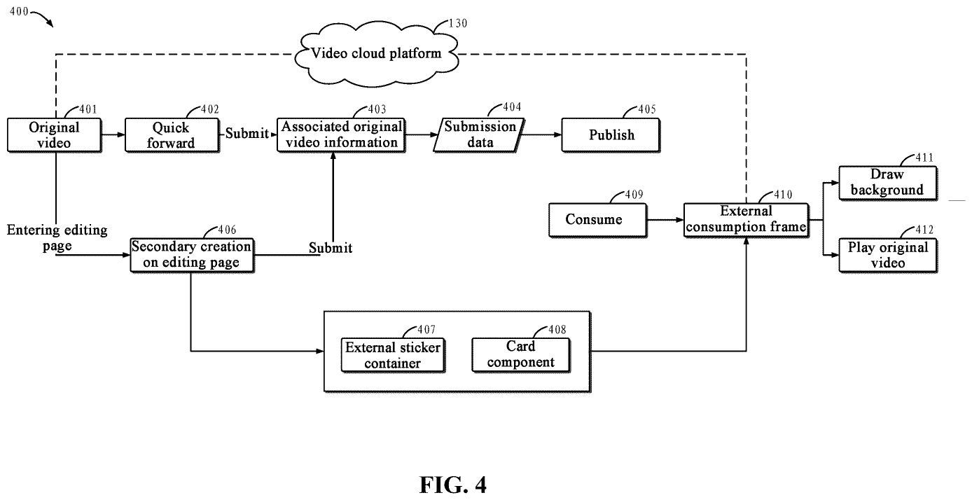

FIG. 4 illustrates a schematic diagram of an example process 400 for exchange of media content between the production side and the consumption side in accordance with some embodiments of the present disclosure. As stated above, the media content may be in various types, including video, image-text, mixed arrangement of views, live streaming, single image-text and single video etc. Embodiments of the present disclosure are not restricted in this regard. The following description is made with video as the media content. Before forwarding and processing the videos of other users, the production-side user is also the consumption-side user when browsing the videos published by other users.

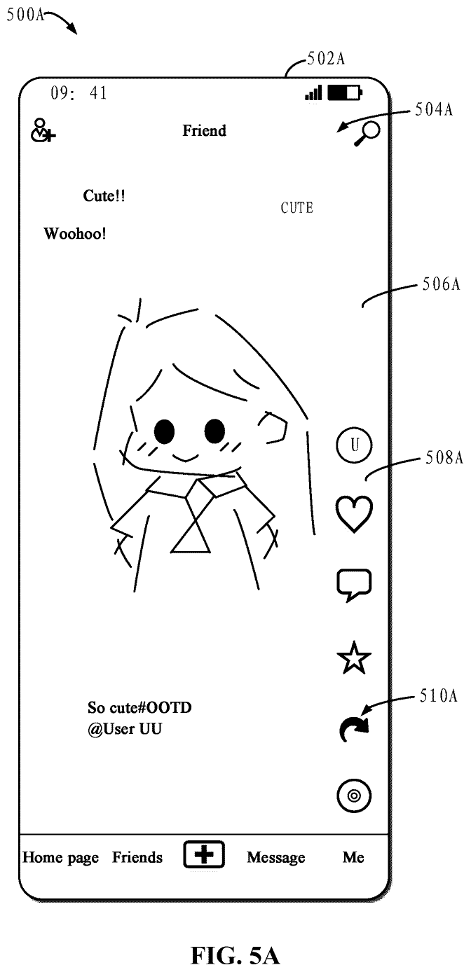

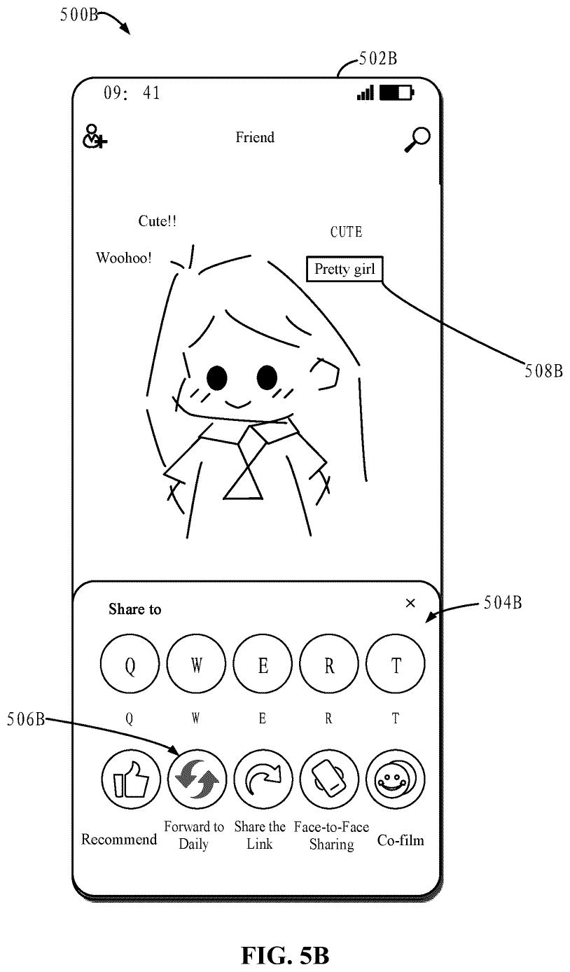

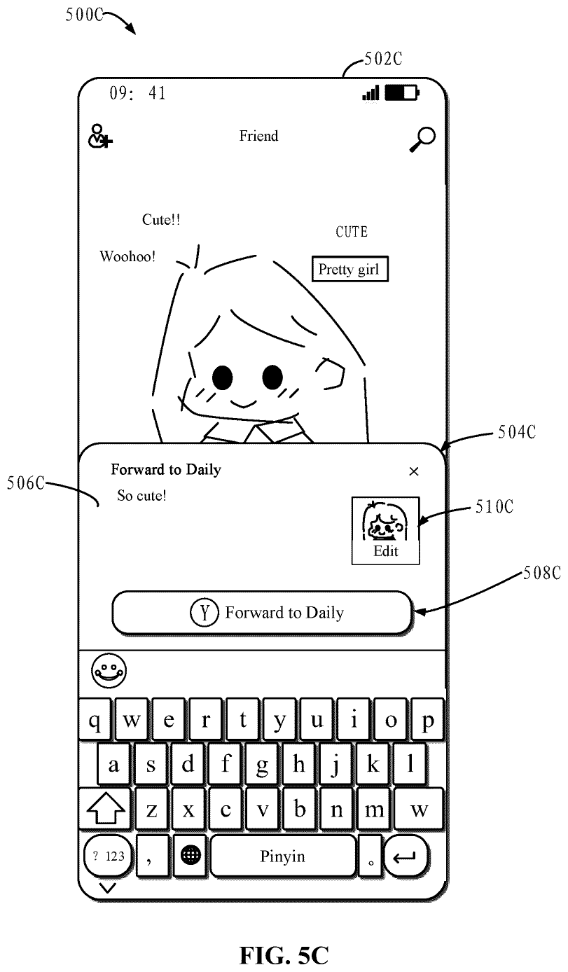

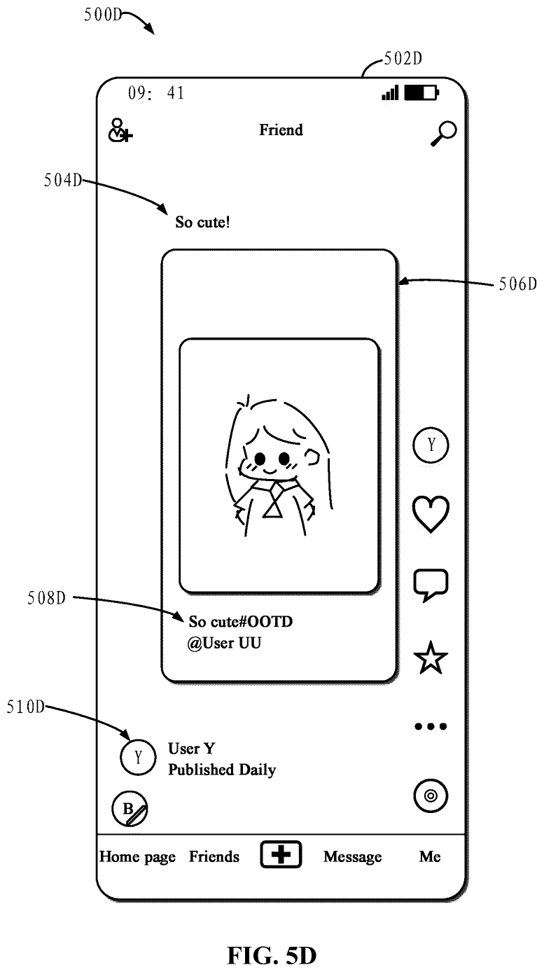

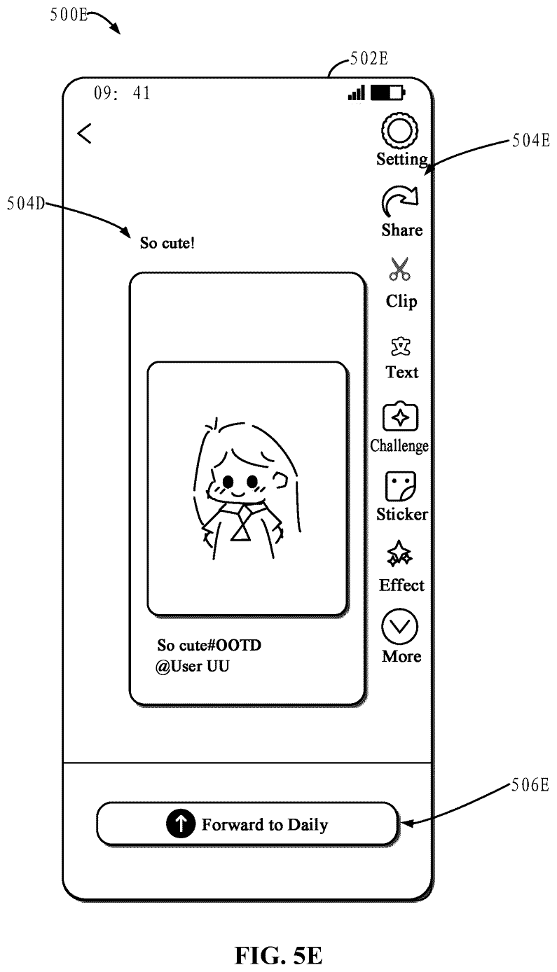

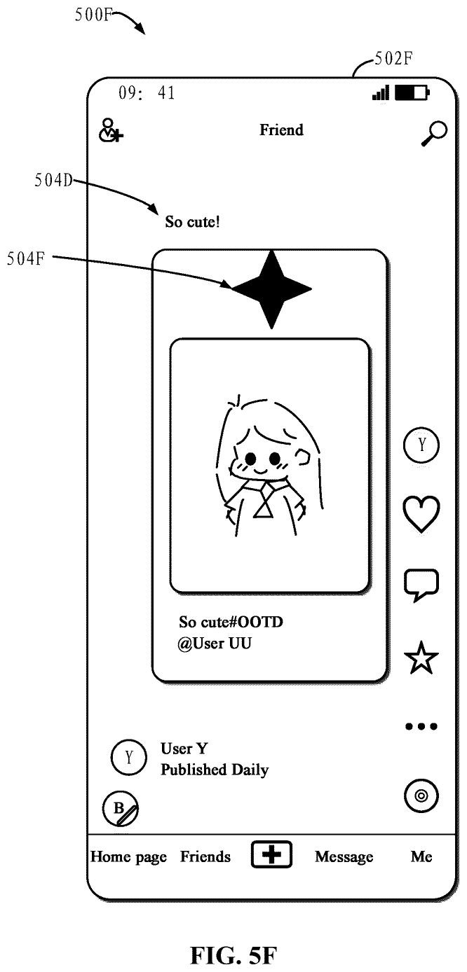

As shown in FIG. 4, the original video 401 is a work published by other users. FIG. 5A illustrates a schematic diagram of an example interface 500A of the media content in accordance with some embodiments of the present disclosure. The display interface shown in FIG. 5A is the presentation page of the original video 401. In the display interface 502A, a navigation area 504, including friend tag, recommendation tag (not shown) and other tags, is displayed at the upper side. At the middle of the display interface 502A, a display area 506A displays the original video 401, in which original video 401, bullet comments on the original video 401 from other users may also be displayed.

With reference to FIG. 5A, other operation controls are displayed in an area 508A at the right side of the display interface 502A. These controls, from top to bottom, include profile photo of the original publisher of the original video 401, “Like” control, “Comment” control, “Favorite” control, “Share” control 510A and “Music” control. For example, the original video 401 is published by the user UU. In such case, the profile display area at the right side would display the profile of the user UU. The consumption-side user may express his/her like and recognition of the video content by touching the “Like” control. The user may post a comment and an opinion about the video content or interact with other users through the “Comment” control. If the video uses a particular music, the “Music” control may display a corresponding music identifier.

As shown in FIG. 5A, the user Y is used as an example. When the user Y intends to forward the video content of the original video 401, the forwarding operation may be implemented by touching the “Share” control 510A. After the user touches the “Share” control 510A, the procedure may jump to FIG. 5B. FIG. 5B illustrates a schematic diagram of an example interface 500B for displaying a share interface in accordance with some embodiments of the present disclosure. With reference to FIG. 5B, a share panel is displayed in the area 504B. Above the share panel, the profile and the nickname of the user to which the user Y may share are displayed. The area below the share panel is displayed with “Recommend” control, “Forward to Daily” control 506B, “Share the Link” control, “Face-to-Face” control and “Co-film” control. The video content display area of the display interface 502B also may display a bullet comment 508B already sent by the user UU with respect to the original video 401.

Referring to FIG. 5B, the user Y may forward the original video 401 of the user UU by touching the “Forward to Daily” control 506B. After it is detected that the user Y touches the “Forward to Daily” control 506B, the information of the original video 401 may be obtained first. The information may include ID and the forwarding information of the original video 401, wherein the forwarding information may include the user interface style and the background color of the original video 401 and the secondary creation script of the user Y (if any) etc. Meanwhile, after it is detected that the user Y touches the “Forward to Daily” control 506B, the procedure may jump to FIG. 5C, which illustrates a schematic diagram of an example interface 500C for displaying the forwarded media content in accordance with some embodiments of the present disclosure. Referring to FIG. 5C, a forward panel in the area 504C of the display interface 502C is displayed with an editing area 506C of the secondary creation script of the user Y, a “Publish” control 508C and an “Edit” control 510C.

Returning to FIG. 4, if the user Y does not need to perform additional operations (besides adding the secondary creation script) on the original video 401, i.e., implementing a quick forward operation on the original video 401 at 402, the original video 401 and the forwarding information may be subsequently associated at 403, so as to generate the submission data 404. The quickly forwarded content is therefore directly published at 405. In some embodiments, the submission data associated with the original video information may be packaged and uploaded to the video cloud platform 430, such that the video cloud platform 430 may push the quick forward content of the user Y to other users at the consumption side. Referring to FIG. 5C, the user Y may publish the quick forward content directly via the “Publish” control 508C on the forward panel of the area 504C. When the user Y quickly forwards the video of the user UU through the “Publish” control 508C, the procedure may jump to FIG. 5D.

FIG. 5D illustrates a schematic diagram of an example interface 500D displayed at the production-side user or the consumption-side user after quick forward of the media content in accordance with some embodiments of the present disclosure. Referring to FIG. 5D, in the display interface 502D, a r secondary creation script 504D “So cute!” of the user Y and a style presentation area 506D of the quickly forwarded original video 401 are displayed. In the area 506D, the publisher identifier of the original video 401 and an area 508D for publishing scripts are displayed. At the bottom of the quick forward video, an identifier area 510D of the user Y (i.e., the publisher of the quick forward) is also displayed.

It is to be understood that the display interface 502D may present on the terminal of the user Y or the terminal of the user UU and other users who consume the quick forward content. When other users at the consumption side consume the quick forward content of the user Y, an interface, like the display interface 502D, may present on the terminal. When it is detected that the consumption-side user consumes the quick forward content of the user Y at 409, the submission data may be downloaded first from the video cloud platform 430. Next, the submission data is parsed to obtain identifier, background and user interface style of the original video 401 and the secondary creation script of the user Y etc., so as to draw the background of the quick forward video content at 411 by means of an external consumption frame 410 and play the original video 401 at 412.

In some embodiments, the quick forward video content of the user Y may be presented by the external player in accordance with the parsed information. For example, the background color of the quick forward video content is drawn by an external sticker container 407 and a card component 408 in the external container, and a content area of the quick forward video of the user Y is then drawn based on the identifier of the original video 401, the secondary creation script of the user Y and the user interface design style in the parsed submission data, so as to consume the quick forward video of the user Y.

Continuing to refer to FIG. 4, if the user Y still needs to perform additional operations (besides adding the secondary creation script) on the original video, i.e., the original video 401 enters an editing page for secondary creation at 406, the information of the secondary creation (which may also be regarded as forwarding information) is also associated with the original video 401 at 403, to generate the submission data 404, thereby publishing the forwarded content at 405. With reference to FIG. 5C, the user Y may recreate the original video 401 through the “Edit” control 510C. When the user touches the “Edit” control 510C, the procedure may jump to FIG. 5E.

FIG. 5E illustrates a schematic diagram of an example interface 500E for displaying and editing the media content in accordance with some embodiments of the present disclosure. Referring to FIG. 5E, a right-side area 504E of the display interface 502E displays edit controls, including “Setting” control, “Share” control, “Clip” control, “Text” control, “Challenge” control, “Sticker” control, “Effects” control and “More” control from top to bottom. For example, it may be configured with the “Setting” control who may view this forwarded content; the video may be clipped and added with transitions via the “Clip” control; different styles, including font, word size, color, bold, italic and underline, may be selected through the “Text” control; the user may place the sticker at any position of the video and adjust the size and angle of the sticker by means of the “Sticker” control, such that the sticker is well-integrated with the video content.

Returning to FIG. 4, in some embodiments, when the user applies these controls (the space indicated by area 504E in FIG. 5E) to adjust the forwarded video content, the adjusted information may all be associated with the video at 403, to form the submission data 404, which are packaged and uploaded to the video cloud platform 430. In some embodiments, if the user adds editing elements, e.g., effects and filters, to the video content, these editing elements may be integrated into a whole background picture or video, such that the editing elements as a whole are packaged into the submission data 404, which are passed to the video cloud platform 430.

With reference to FIG. 5E, the user may add a sticker to the video display area of the display interface 502E through the “Sticker” control. After completing the adjustments of the video content, the user Y may publish the forwarded and adjusted video content to the video platform through the “Publish” control 506E. As such, other users at the consumption side may consume the video content forwarded by the user Y.

In some embodiments, after the user Y publishes the forwarded and adjusted video content through the “Publish” control 506E, the procedure may jump to FIG. 5F. FIG. 5F illustrates a schematic diagram of an example interface 500F for displaying the edited media content on the terminal of the user at the production side or the consumption side in accordance with some embodiments of the present disclosure. With reference to FIG. 5F, the sticker 504F added to the video by the user Y is displayed on the display interface 502F.

It is to be appreciated that the interface shown in FIG. 5F also may be the display interface in which other users may consume the video forwarded by the user Y. When other users at the consumption side consume the quick forward content of the user Y, an interface, like the display interface 502F, may present on their terminal. When it is detected that the consumption-side user consumes the quick forward content of the user Y at 409, the submission data may be downloaded first from the video cloud platform 430. Next, the submission data is parsed to obtain identifier, background and user interface style of the original video 401 and the secondary creation script, effects and filter stickers of the user Y etc., so as to draw the background of the quick forward video content at 411 by means of an external consumption frame 410 and play the original video 401 at 412.

In some embodiments, the quick forward video content of the user Y may be presented by the external player in accordance with the parsed information. For example, the background color of the quick forward video content is drawn by an external sticker container 407 and a card component 408 in the external container and a content area of the quick forward video of the user Y is then drawn based on the identifier of the original video 401, the secondary creation script and the user interface design style of the user Y, and the background picture or video synthesized from the above effects, filters and stickers in the parsed submission data, so as to consume the quick forward video of the user Y.

The method free of re-synthesizing the media content facilitates exchange of videos between the production and the consumption sides. In addition to expediting the speed for publishing the video forwarded by the production-side user, the method also can enhance the visual effects of these forwarded videos when viewed by the users at the consumption side, and further improve the user experience.

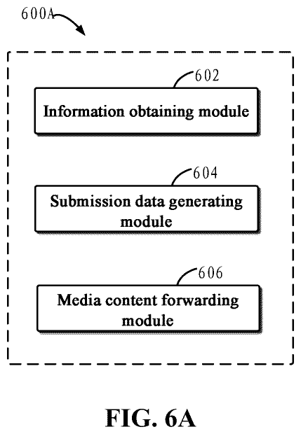

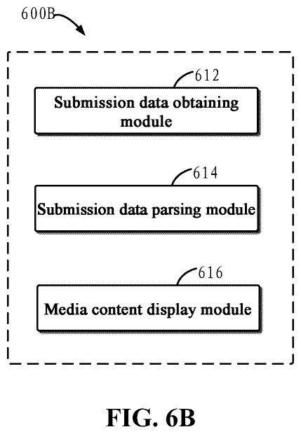

FIG. 6A illustrates a block diagram of an apparatus 600A for forwarding media content in accordance with some embodiments of the present disclosure. As shown in FIG. 6A, the apparatus 600A comprises an information obtaining module 602 configured to obtain information of media content in response to detecting a touch on a first control by a user, wherein the media content comprises at least one of a video, image-text, a mixed arrangement of views and live streaming, and information of the media content comprises an identifier of the media content and forwarding information, wherein the mixed arrangement of views indicates a mixed arrangement of videos and pictures, and the forwarding information includes at least one of a user interface style of the media content, a background color of the media content and a new script of user. The apparatus 600A also comprises a submission data generating module 604 configured to generate submission data by associating the media content with information of the media content. Moreover, the apparatus 600A also comprises media content forwarding module 606 configured to forward the media content based on the submission data in response to detecting a touch on a second control by a user

FIG. 6B illustrates a block diagram of an apparatus 600B for displaying media content in accordance with some embodiments of the present disclosure. As shown in FIG. 6B, the apparatus 600B comprises a submission data obtaining module 612 configured to obtain submission data in response to detecting an operation of browsing the media content by a user, wherein the submission data is at least associated with the media content and information of the media content; and information of the media content at least includes an identifier and forwarding information of the media content; and the forwarding information includes at least one of a user interface style of the media content, a background color of the media content and a new script of user. The apparatus 600B also comprises a submission data parsing module 614 configured to parse the submission data to obtain the parsed media content and information of the media content. Moreover, the apparatus 600B also comprises media content display module 616 configured to display the media content hierarchically based on the parsed media content and information of the media content.

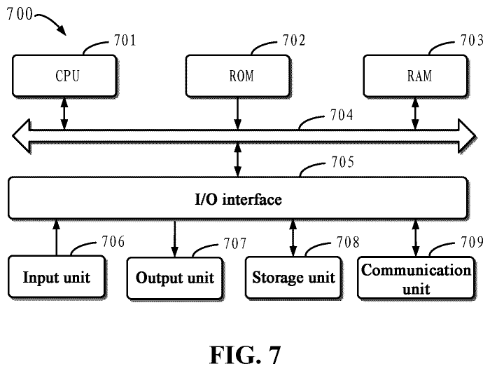

FIG. 7 illustrates a block diagram of a device 700 capable of implementing a plurality of embodiments of the present disclosure. As shown in FIG. 7, the device 700 comprises a central process unit (CPU) and/or graphics processing unit (GPU) 701, which can execute various suitable actions and processing based on the computer program instructions stored in the read-only memory (ROM) 702 or computer program instructions loaded in the random-access memory (RAM) 703 from the storage unit 708. The RAM 703 can also store all kinds of programs and data required by the operation of the device 700. CPU/GPU 701, ROM 702 and RAM 703 are connected to each other via a bus 704. The input/output (I/O) interface 705 is also connected to the bus 704. Although not illustrated in FIG. 7, the device 700 also may include a coprocessor.

A plurality of components in the device 700 is connected to the I/O interface 705, including: an input unit 706, such as keyboard, mouse and the like; an output unit 707, e.g., various kinds of display and loudspeakers etc. ; a storage unit 708, such as disk and optical disk etc. ; and a communication unit 709, such as network card, modem, wireless transceiver and the like. The communication unit 709 allows the device 700 to exchange information/data with other devices via the computer network, such as Internet, and/or various telecommunication networks.

The above described respective methods can be executed by the GPU/CPU 701. For example, in some embodiments, the method can be implemented as a computer software program tangibly included in the machine-readable medium, e.g., storage unit 708. In some embodiments, the computer program can be partially or fully loaded and/or mounted to the apparatus 700 via ROM 702 and/or communication unit 709. When the computer program is loaded to RAM 703 and executed by the CPU/GPU 701, one or more steps or actions of the above described method or procedure may be executed.

In some embodiments, the above described method and procedure may be implemented as a computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages and traditional procedural programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by device, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure.

Some example implementations are listed below.

Example 1. A method for forwarding media content, comprising:
in response to detecting a touch on a first control by a user, obtaining information of media content, the media content comprising at least one of a video, image-text, a mixed arrangement of views and live streaming, information of the media content comprising an identifier of the media content and forwarding information, the mixed arrangement of views indicating a mixed arrangement of a video and a picture, the forwarding information comprising at least one of a user interface style of the media content, a background color of the media content and a new script of user;
generating submission data by associating the media content with information of the media content; and
in response to detecting a touch on a second control by a user, forwarding the media content based on the submission data.

Example 2. The method of Example 1, further comprising:
in response to detecting a touch on a third control by a user, displaying an editing page for the media content, the editing page displaying a plurality of different editing element controls for the media content, the editing element controls being used for adjusting the media content.

Example 3. The method of any of Examples 1-2, further comprising:
in response to detecting a touch on each of different editing element controls in the editing page by a user, determining information for each editing element.

Example 4. The method of any of Examples 1-3, further comprising:
synthesizing background information based on the determined information for each editing element, the background information indicating a video or a picture related to each editing element.

Example 5. The method of any of Examples 1-4, wherein the generating submission data by associating the media content with information of the media content comprises:
generating the submission data by packaging the media content, information of the media content and the synthesized background information.

Example 6. The method of any of Examples 1-5, further comprising:
playing and displaying the media content by an external player based on the submission data.

Example 7. The method of any of Examples 1-6, further comprising:
sending the submission data to a server, the server being used for storing the media content and data related to the media content.

Example 8. A method for displaying media content, comprising:
in response to detecting an operation of browsing the media content by a user, obtaining submission data, the submission data being at least associated with the media content and information of the media content, information of the media content at least comprising an identifier of the media content and forwarding information, the forwarding information comprising at least one of a user interface style of the media content, a background color of the media content and a new script of user;
parsing the submission data to obtain the parsed media content and information of the media content; and
displaying the media content hierarchically based on the parsed media content and information of the media content.

Example 9. The method of Example 8, wherein displaying the parsed media content hierarchically based on the media content and information of the media content comprises:
determining, by a card component in an external container, the background color of the media content and a display area of the media content based on the parsed forwarding information.

Example 10. The method of any of Examples 8-9, further comprising:
determining, by the card component, an identifier of the media content, a user interface style of the media content and a new script of the user based on the information of the parsed media content.

Example 11. The method of any of Examples 8-10, further comprising:
in response to the submission data being associated with an editing element, determining synthesized background information for the editing element, the background information indicating a video or a picture related to each editing element.

Example 12. The method of any of Examples 8-11, further comprising:
displaying the media content hierarchically in the display area by an external player based on the background color of the media content, an identifier of the media content, a new script of the user and the synthesized background information.

Example 13. The method of any of Examples 8-12, further comprising:
receiving the submission data from a server, the server being used for storing media content and data related to the media content.

Example 14. An apparatus for forwarding media content, comprising:
an information obtaining module configured to obtain information of media content in response to detecting a touch on a first control by a user, the media content comprising at least one of a video, image-text, a mixed arrangement of views and live streaming, information of the media content comprising an identifier of the media content and forwarding information, the mixed arrangement of views indicating a mixed arrangement of a video and a picture, the forwarding information comprising at least one of a user interface style of the media content, a background color of the media content and a new script of user;
a submission data generating module configured to generate submission data by associating the media content with information of the media content; and
media content forwarding module configured to forward the media content based on the submission data in response to detecting a touch on a second control by a user.

Example 15. The apparatus of Example 14, further comprising:
a first display module configured to display an editing page for the media content in response to detecting a touch on a third control by a user, the editing page displaying a plurality of different editing element controls for the media content, the editing element controls being used for adjusting the media content.

Example 16. The apparatus of any of Examples 14-15, further comprising:
a first determining module configured to determine information for each editing element in response to detecting a touch on each of different editing element controls in the editing page by a user.

Example 17. The apparatus of any of Examples 14-16, further comprising:
a first synthesis module configured to synthesize background information based on the determined information for each editing element, the background information indicating a video or a picture related to each editing element.

Example 18. The apparatus of any of Examples 14-17, wherein the submission data generating module comprises:
a first generation module configured to generate the submission data by packaging the media content, information of the media content and the synthesized background information.

Example 19. The apparatus of any of Examples 14-18, further comprising:
a first play module configured to playing and displaying the media content by an external player based on the submission data.

Example 20. The apparatus of any of Examples 14-19, further comprising:
a first sending module configured to send the submission data to a server, the server being used for storing the media content and data related to the media content.

Example 21. An apparatus for displaying media content, comprising:
a submission data obtaining module configured to obtain submission data in response to detecting an operation of browsing the media content by a user, the submission data being at least associated with the media content and information of the media content, information of the media content at least comprising an identifier of the media content and forwarding information, the forwarding information comprising at least one of a user interface style of the media content, a background color of the media content and a new script of user;
a submission data parsing module configured to parse the submission data to obtain the parsed media content and information of the media content; and
a media content display module configured to display the media content hierarchically based on the parsed media content and information of the media content.

Example 22. The apparatus of Example 21, wherein the media content display module comprises:
a second determining module configured to determine, by a card component in an external container, the background color of the media content and a display area of the media content based on the forwarding information parsed.

Example 23. The apparatus of any of Examples 21-22, further comprising:
a third determining module configured to determine, by the card component, an identifier of the media content, a user interface style of the media content and a new script of the user based on the parsed information of the media content.

Example 24. The apparatus of any of Examples 21-23, further comprising:
a fourth determining module configured to determine, in response to the submission data being associated with an editing element, synthesized background information for the editing element, the background information indicating a video or a picture related to each editing element.

Example 25. The apparatus of any of Examples 21-24, further comprising:
a second display module configured to display the media content hierarchically in the display area by an external player based on the background color of the media content, an identifier of the media content, a new script of the user and the synthesized background information.

Example 26. The apparatus of any of Examples 21-25, further comprising:
a first receiving module configured to receive the submission data from a server, the server being used for storing media content and data related to the media content.

Example 27. An electronic device, comprising:
a processor; and
a memory coupled to the processor and having instructions stored therein, wherein the instructions, when executed by a processor, cause the electronic device to perform acts comprising:
in response to detecting a touch on a first control by a user, obtaining information of media content, the media content comprising at least one of a video, image-text, a mixed arrangement of views and live streaming, information of the media content comprising an identifier of the media content and forwarding information, the mixed arrangement of views indicating a mixed arrangement of a video and a picture, the forwarding information comprising at least one of a user interface style of the media content, a background color of the media content and a new script of user;
generating submission data by associating the media content with information of the media content; and
in response to detecting a touch on a second control by a user, forwarding the media content based on the submission data.

Example 28. The electronic device of Example 27, further comprising:
in response to detecting a touch on a third control by a user, displaying an editing page for the media content, the editing page displaying a plurality of different editing element controls for the media content, the editing element controls being used for adjusting the media content.

Example 29. The electronic device of any of Examples 27-28, further comprising:
in response to detecting a touch on each of different editing element controls in the editing page by a user, determining information for each editing element.

Example 30. The electronic device of any of Examples 27-29, further comprising:
synthesizing background information based on determined information for each editing element, the background information indicating a video or a picture related to each editing element.

Example 31. The electronic device of any of Examples 27-30, wherein generating submission data by associating the media content and information of the media content comprises:
generating the submission data by packaging the media content, information of the media content and the synthesized background information.

Example 32. The electronic device of any of Examples 27-31, further comprising:
playing and displaying the media content by an external player based on the submission data.

Example 33. The electronic device of any of Examples 27-32, further comprising:
sending the submission data to a server, the server being used for storing the media content and data related to the media content.

Example 34. A method for displaying media content, comprising:
in response to detecting an operation of browsing the media content by a user, obtaining submission data, the submission data being at least associated with the media content and information of the media content;
information of the media content at least comprising an identifier of the media content and forwarding information, the forwarding information comprising at least one of a user interface style of the media content, a background color of the media content and a new script of user;
parsing the submission data to obtain the parsed media content and information of the media content; and
displaying the media content hierarchically based on the media content and information of the parsed media content.

Example 35. The electronic device of Example 34, wherein displaying the media content hierarchically based on the parsed media content and information of the media content comprises:
determining, by a card component in an external container, the background color of the media content and a display area of the media content based on the forwarding information parsed.

Example 36. The electronic device of any of Examples 34-35, further comprising:
determining, by the card component, an identifier of the media content, a user interface style of the media content and a new script of the user based on the information of the media content parsed.

Example 37. The electronic device of any of Examples 34-36, further comprising:
in response to the submission data being associated with an editing element, determining synthesized background information for the editing element, the background information indicating a video or a picture related to each editing element.

Example 38. The electronic device of any of Examples 34-37, further comprising:
displaying the media content hierarchically in the display area by an external player based on the background color of the media content, an identifier of the media content, a new script of the user and the synthesized background information.

Example 39. The electronic device of any of Examples 34-38, further comprising:
receiving the submission data from a server, the server being used for storing media content and data related to the media content.

Example 40. A computer-readable storage medium stored thereon with computer-executable instructions, wherein the computer-executable instructions, when executed by a processor, implement the method according to any of Examples 1-7.

Example 41. A computer-readable storage medium stored thereon with computer-executable instructions, wherein the computer-executable instructions, when executed by a processor, implement the method according to any of Examples 8-13.

Example 42. A computer program product tangibly stored on a non-transitory computer-readable medium and comprising computer-executable instructions, wherein the computer-executable instructions, when executed by a device, cause the device to implement the method according to any of Examples 1-7.

Example 43. A computer program product tangibly stored on a non-transitory computer-readable medium and comprising computer-executable instructions, wherein the computer-executable instructions, when executed by a device, cause the device to implement the method according to any of Examples 8-13.

Although the present disclosure has been described in a language specific to structural features and/or logical actions of the methods, it should be understood that the subject matter defined in the appended claims is not necessarily limited to the specific features or actions described above. On the contrary, the specific features and actions described above are only exemplary forms for implementing the claims.

I/We claim:

1. A method for forwarding media content, comprising:
in response to detecting a touch on a first control by a user, obtaining information of media content, the media content comprising at least one of a video, image-text, a mixed arrangement of views and live streaming, information of the media content comprising an identifier of the media content and forwarding information, the mixed arrangement of views indicating a mixed arrangement of a video and a picture, the forwarding information comprising at least one of a user interface style of the media content, a background color of the media content and a new script of user;
generating submission data by associating the media content with information of the media content; and
in response to detecting a touch on a second control by a user, forwarding the media content based on the submission data.

2. The method of claim 1, further comprising:
in response to detecting a touch on a third control by a user, displaying an editing page for the media content, the editing page displaying a plurality of different editing element controls for the media content, the editing element controls being used for adjusting the media content.

3. The method of claim 2, further comprising:
in response to detecting a touch on each of different editing element controls in the editing page by a user, determining information for each editing element.

4. The method of claim 3, further comprising:
synthesizing background information based on the determined information for each editing element, the background information indicating a video or a picture related to each editing element.

5. The method of claim 4, wherein generating submission data by associating the media content with information of the media content comprises:
generating the submission data by packaging the media content, information of the media content and the synthesized background information.

6. The method of claim 5, further comprising:
playing and displaying the media content by an external player based on the submission data.

7. The method of claim 6, further comprising:
sending the submission data to a server, the server being used for storing the media content and data related to the media content.

8. A method for displaying media content, comprising:
in response to detecting an operation of browsing the media content by a user, obtaining submission data, the submission data being at least associated with the media content and information of the media content, information of the media content at least comprising an identifier of the media content and forwarding information, the forwarding information comprising at least one of a user interface style of the media content, a background color of the media content and a new script of user;
parsing the submission data to obtain the parsed media content and information of the media content ; and
displaying the media content hierarchically based on the parsed media content and information of the media content.

9. The method of claim 8, wherein displaying the media content hierarchically based on the parsed media content and information of the media content comprises:
determining, by a card component in an external container, the background color of the media content and a display area of the media content based on the parsed forwarding information.

10. The method of claim 9, further comprising:
determining, by the card component, an identifier of the media content, a user interface style of the media content and a new script of the user based on the information of the parsed media content.

11. The method of claim 10, further comprising:
in response to the submission data being associated with an editing element, determining synthesized background information for the editing element, the background information indicating a video or a picture related to each editing element.

12. The method of claim 11, further comprising:
displaying the media content hierarchically in the display area by an external player based on the background color of the media content, an identifier of the media content, a new script of the user and the synthesized background information.

13. The method of claim 8, further comprising:
receiving the submission data from a server, the server being used for storing media content and data related to the media content.

14. An electronic device, comprising:
a memory and a processor;
wherein the memory is configured to store one or more computer instructions which, when executed by the processor, cause the processor to:
in response to detecting a touch on a first control by a user, obtain information of media content, the media content comprising at least one of a video, image-text, a mixed arrangement of views and live streaming, information of the media content comprising an identifier of the media content and forwarding information, the mixed arrangement of views indicating a mixed arrangement of a video and a picture, the forwarding information comprising at least one of a user interface style of the media content, a background color of the media content and a new script of user;
generate submission data by associating the media content with information of the media content; and
in response to detecting a touch on a second control by a user, forward the media content based on the submission data.

15. The device according to claim 14, further comprising instructions causing the processor to:
in response to detecting a touch on a third control by a user, display an editing page for the media content, the editing page displaying a plurality of different editing element controls for the media content, the editing element controls being used for adjusting the media content.

16. The device according to claim 15, further comprising instructions causing the processor to:
in response to detecting a touch on each of different editing element controls in the editing page by a user, determine information for each editing element.

17. The device according to claim 16, further comprising instructions causing the processor to:
synthesize background information based on the determined information for each editing element, the background information indicating a video or a picture related to each editing element.

18. The device according to claim 17, wherein the instructions causing the processor to generate submission data by associating the media content with information of the media content comprise instructions causing the processor to:
generate the submission data by packaging the media content, information of the media content and the synthesized background information.

19. The device according to claim 18, further comprising instructions causing the processor to:
play and display the media content by an external player based on the submission data.

20. The device according to claim 19, further comprising instructions causing the processor to:
send the submission data to a server, the server being used for storing the media content and data related to the media content.
